(19) United States
(12) Patent Application Publication
(10) Pub. No.: US 2017/0088443 A1
(43) Pub. Date: Mar. 30, 2017

(54) ELECTROKINETIC PURIFICATION DEVICE

(71) Applicant: United States of America as Represented by the Secretary of the Army, Alexandria, VA (US)

(72) Inventor: Aaron T. Timperman, Barrington, IL (US)

(21) Appl. No.: 14/871,599

(22) Filed: Sep. 30, 2015

(51) Int. Cl. C02F 1/46; C02F 1/469

(52) U.S. Cl. CPC C02F 1/4604; C02F 1/4696; C02F 2103/08

(57) ABSTRACT

An electrokinetic purification device includes at least three channels and a turbulence-reduction component for reducing turbulence with the concentration polarization (CP) zone. The main channel includes a pair of electrodes in contact with a solvent stream entering and exiting the main channel. A waste diversion channel branches from the main channel, allowing flow-through of a high concentration portion of the stream. A turbulence-reduction component comprised of a neutrally charged porous is placed across the entire interior cross section of the main channel and in contact with the upstream surface of the permselective material. The clean solvent discharge channel branches from the main channel, allowing flow-through of a low concentration portion of the stream.

### STATEMENT OF GOVERNMENT INTEREST

The invention described herein was made by an employee of the United States Government and may be manufactured and used by the Government of the United States of America for governmental purposes without the payment of any royalties thereon or therefore.

### BACKGROUND

1. Field of Invention

This invention relates to the field of liquid purification, and more specifically to a device for removing ions.

2. Description of the Related Art

Electrokinetic purification is a process used to remove salt and other ionic contaminants from solvents such as water. During the filtering process, a system runs voltage across a channel containing a filter membrane constructed from electrically charged material. The electrical charge of the membrane repels ions that might otherwise adhere to the membrane surface and obstruct flow of water.

Theoretically, performance of electrokinetic filtration may be on any scale, making the process applicable to nano-scale operations as well as large-scale water purification for public systems. However, electrokinetic filtering systems known in the art are impractical for large-scale purification operations. The channel size of the devices is limited (e.g., approximately 100 microns). As channel size increases, the device is destabilized by turbulence from the constant mixing of low-contaminant liquid near the filter with high-contaminant liquid from further away from the filter.

In addition, electrokinetic devices known in the art are not energy efficient and have costly filters subject that are subject to fouling. These filters must be changed frequently, resulting in system down time.

There is an unmet need for efficient electrokinetic filtering systems that are practical for use large-scale water purification projects.

### SUMMARY OF THE INVENTION

In accordance with one embodiment, an electrokinetic purification device includes a main channel, at least one waste diversion channel, at least one porous permselective material, a concentration polarization (CP) region, a turbulence-reduction component and at least one clean solvent discharge channel. The main channel includes a first electrode in contact with a solvent stream entering the main channel and a second electrode in contact with the solvent stream exiting the main channel. At least one waste diversion channel branches from the main channel. A high concentration portion of the solvent stream flows through the waste diversion channel. At least one porous permselective material having an upstream surface and a downstream surface is placed across substantially the entire interior cross section of the main channel. This requires the solvent stream to pass though the permselective material between the first and the second electrodes. The CP region within the solvent stream forms by contact of a low concentration region of the solvent stream with the upstream surface. The turbulence-reduction component is a porous material having a neutral charge. The turbulence-reduction component is placed across substantially the entire interior cross section of the main channel and contacts the upstream surface. At least one clean solvent discharge channel branches from the main channel. A low concentration portion of the solvent stream flows through the clean solvent discharge channel and is discharged from the main channel at a point before the solvent stream passes through the permselective material.

In accordance with another embodiment, an electrokinetic purification system includes a plurality of electrokinetic purification devices as described above, a primary input channel in fluid communication with a first end of each of the main channels, a primary output channel in fluid communication with a second end of each of the main channels, and a housing at least partially surrounding the plurality of electrokinetic purification devices, the primary input channel and the primary output channel.

In accordance with another embodiment, a method for making an electrokinetic purification device includes the steps of creating a main channel, at least one waste diversion channel branching from the main channel and at least one clean solvent discharge channel branching from the main channel, placing a permselective material across substantially the entire interior cross section of the main channel and downstream of the at least one clean solvent discharge channel, preparing a neutrally charged porous material forming a turbulence-reduction component and placing the turbulence-reduction component across substantially the entire interior cross section of the main channel, downstream of the at least one waste diversion channel and in contact with an upstream surface of the permselective material, placing a first electrode within the main channel such that the first electrode will contact a solvent stream entering the main channel and placing a second electrode within the main channel such that the second electrode will contact the solvent stream exiting the main channel.

### BRIEF DESCRIPTION OF THE DRAWINGS

FIG. 1 illustrates an exemplary embodiment of an electrokinetic purification device with a stabilized CP region.

FIG. 2 illustrates an exemplary embodiment of an electrokinetic purification system incorporating multiple electrokinetic purification devices for larger-scale purification.

FIG. 3 illustrates a flowchart of an exemplary method for making an electrokinetic purification device with a turbulence-reduction component.

### TERMS OF ART

As used herein, the term “concentration polarization region” or “CP region” means an area in which the application of voltage alters the concentration of ions.

As used herein, the term “high concentration portion of a solvent stream” means a portion of a solvent stream having a higher concentration of impurities than the solvent stream.

As used herein, the term “low concentration portion of a solvent stream” means a portion of a solvent stream having a lower concentration of impurities than the solvent stream.

As used herein, the term “permselective” means a material characteristic of restrictive permeation of molecules based on molecular size, charge, and/or physical configuration.

As used herein, the term “pore” means a void in a mass of material, an interstitial space between two or more masses of material or a substantially straight capillary.

As used herein, the term “porous” means the state of having either a void in a mass of material, an interstitial space between two or more masses of material or a substantially straight capillary in a mass of material.

As used herein, the term “purification” or “purified” refers to the reduction or removal of ionic contaminants from a solvent.

As used herein, the term “region” means an area or division having definable characteristics.

### DETAILED DESCRIPTION OF INVENTION

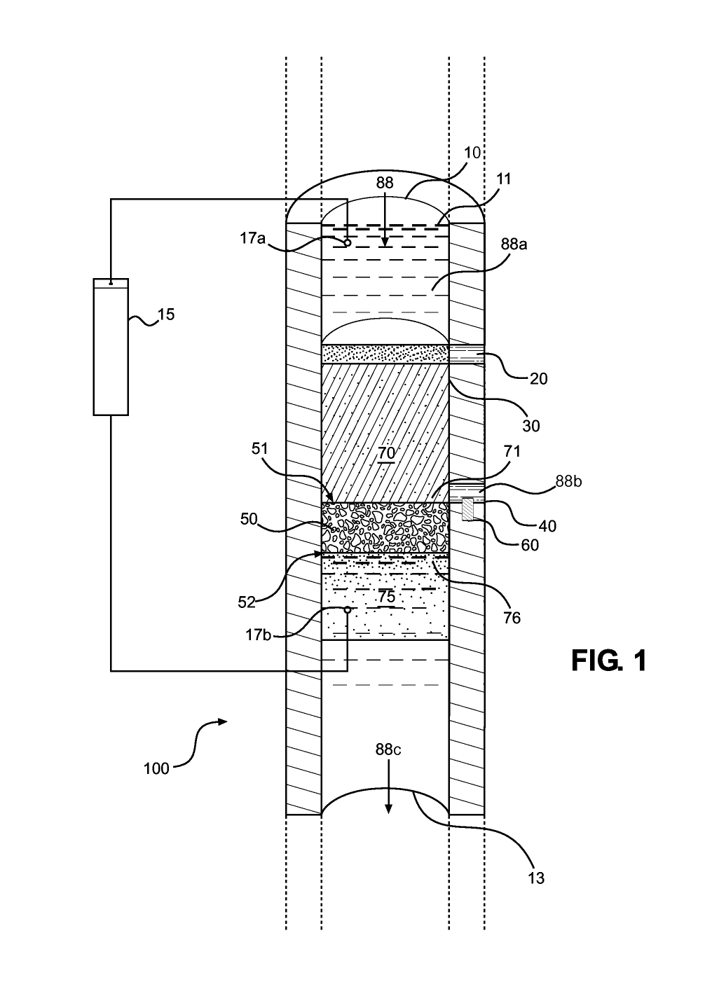

FIG. 1 illustrates an exemplary embodiment of an electrokinetic purification device 100 with a stabilized CP region. Electrokinetic purification device 100 includes a main channel 10, at least one waste diversion channel 20, a turbulence-reduction component 30, at least one clean solvent discharge channel 40, a permselective material 50 and an optional purity detector 60.

Main channel 10 has a first end 11 and a second end 13. A solvent stream 88 enters main channel 10 at first end 11 and exits main channel 10 at second end 13 as purified stream 88c. The diameter of main channel 10 may range from approximately 10 microns to approximately 100 centimeters. Power supply 15 provides power to first electrode 17a and second electrode 17b. First electrode 17a and second electrode 17b are in contact with solvent stream 88 in main channel 10, applying an electrical potential across main channel 10. The electrical potential ranges from approximately 1 V to approximately 10,000 V.

Waste diversion channel 20 provides a means for the removal of a high concentration portion 88a of solvent stream 88. High concentration portion 88a of solvent steam 88 has a higher concentration of impurities than said solvent stream 88 had upon entering main channel 10. For example, when using electrokinetic purification device 100 in a seawater desalination process, waste diversion channel 20 will draw off brine with a higher concentration of salt than the input seawater.

Waste diversion channel 20 is an outlet branching from main channel 10. In one embodiment, waste diversion channel 20 is a single linear channel branching from the side of main channel 10. In another embodiment, waste diversion channel 20 is an annular channel branching to at least partially surround main channel 10. In another embodiment, waste diversion channel 20 is a plurality of channels branching from the side of main channel 10. Waste diversion channel 20 has a diameter less than the diameter of main channel 10.

Turbulence-reduction component 30 stabilizes a first concentration polarization (CP) region 70 within said solvent stream 88 by suppressing convection currents in first CP region 70. This ensures that solvent with higher concentrations of ionic contaminants is spaced away from permselective material 50. Moreover, turbulence-reduction component 30 allows draw-off of purified solvent through clean solvent discharge channel 40 before crossing permselective material 50, thereby reducing the fouling of permselective material 50. Turbulence-reduction component 30 is located within main channel 10, placed across substantially the entire interior cross section of said main channel 10. While turbulence-reduction component 30 physically contacts permselective material 50, it does not infiltrate the pores of permselective material 50. At equilibrium, the length of turbulence-reduction component 30 is less than the length of first CP region 70.

Material forming turbulence-reduction component 30 is porous and substantially neutrally charged so as to not support concentration polarization. In one embodiment, material forming turbulence-reduction component 30 is a porous gel, such as, but not limited to, agarose materials or polyacrylamide. In another embodiment, material forming turbulence-reduction component 30 is a plurality of beads, such as, but not limited to, polymer beads or glass beads. In another embodiment, material forming turbulence-reduction component 30 is frit, such as, but not limited to, metal, glass or polymer frit. In another embodiment, material forming turbulence-reduction component 30 is a polymer membrane. In another embodiment, material forming turbulence-reduction component 30 is a porous mass of metal, such as, but not limited to, porous aluminum or porous stainless steel. In another embodiment the, material forming turbulence-reduction component 30 is a fiber material, such as, but not limited to, a polymer filter pad. The diameter of the pores in turbulence-reduction component 30 ranges from approximately 0.1 micron to approximately 10 mm.

Clean solvent discharge channel 40 provides a means for the removal of a low concentration portion 88b of solvent stream 88. Low concentration portion 88b of solvent steam 88 has a lower concentration of impurities than said solvent stream 88 had upon entering main channel 10. For example, when using electrokinetic purification device 100 in a seawater desalination process, clean solvent discharge channel 40 will draw off water with a lower concentration of salt than the input solvent. Because low concentration portion 88b discharges from main channel 10 at a point before solvent stream 88 passes through permselective material 50, this reduces the volume of solvent stream 88 passing through permselective material 50.

Clean solvent discharge channel 40 is an outlet branching from main channel 10 before permselective element 50. In one embodiment, clean solvent discharge channel 40 is a single linear channel branching from the side of main channel 10. In another embodiment, clean solvent discharge channel 40 is an annular channel branching to at least partially surround main channel 10. In another embodiment, clean solvent discharge channel 40 is a plurality of channels branching from the side of main channel 10.

Permselective material 50 is located downstream of clean solvent discharge channel 40, placed across substantially the entire interior cross-section of main channel 10. Permselective material 50 has an upstream surface 51 and a downstream surface 52. Upstream surface 51 contacts turbulence-reduction component 30. Permselective material 50 is a substantially charged, porous material, such as, but not limited to, gel, membrane, polymer, alumina, silica, or zeolite. In one embodiment, permselective material 50 is an ion track etched membrane or an ion exchange membrane, such as, but not limited to, a sulfonated tetrafluoroethylene based fluoropolymer-copolymer (Nafion®). The diameters of the pores in permselective material 50 are small enough to induce CP, ranging from approximately 1 nm to approximately 500 nm.

First CP region 70 within solvent stream 88 forms by contact between low concentration region 71 of solvent stream 88 and upstream surface 51. A second CP region 75 within solvent stream 88 forms by contact between a high concentration region 76 of solvent stream 88 and downstream surface 52.

Optionally, electrokinetic purification device 100 includes purity detector 60 located in channel 40. Because ionic contaminants increase solvent conductivity, a user may use purity detector 60 to measure conductivity to ensure effective removal of ionic contaminants. An increase in the conductivity of solvent downstream of permselective material 50 may signal inadequate purification.

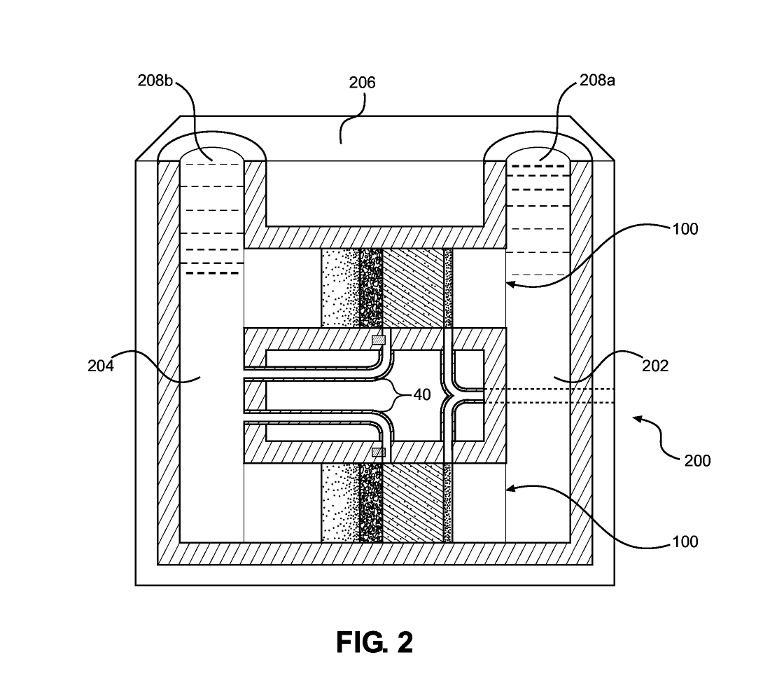

FIG. 2 illustrates an exemplary embodiment of an electrokinetic purification system 200 incorporating multiple electrokinetic purification devices 100 for larger-scale purification. System 200 includes a plurality of electrokinetic purification devices 100, a primary input channel 202, a primary output channel 204 and a housing 206.

Electrokinetic purification devices 100 are located between primary input channel 202 and primary output channel 204. The number of electrokinetic purification devices 100 used may range from approximately 2 to approximately 10,000.

Each main channel 10 of each electrokinetic purification device 100 is in contact with primary input channel 202 at first end 11. In the exemplary embodiment, each main channel 10 branches off from primary input channel 202. In another embodiment, primary input channel 202 divides to form each main channel 10. In another embodiment, primary input channel 202 is made up of individual channels fed from a larger upstream channel.

Each main channel 10 of each electrokinetic purification device 100 is in contact with primary output channel 204 at second end 13. In the exemplary embodiment, each main channel 10 separately joins to primary output channel 204. In another embodiment, main channels 10 converge to form primary output channel 204. In another embodiment, primary output channel 204 is made up of individual channels feeding into a larger downstream channel. In the embodiment shown in FIG. 2, clean solvent discharge channels 40 are in contact with primary output channel 204. In other embodiments, clean solvent discharge channels 40 may form a separate output or outputs from primary output channel 204.

Housing 206 at least partially encases electrokinetic purification devices 100, primary input channel 202 and primary output channel 204. Housing 206 may include at least one aperture 208a leading to primary input channel 202 and at least one aperture 208b leading to primary output channel 204.

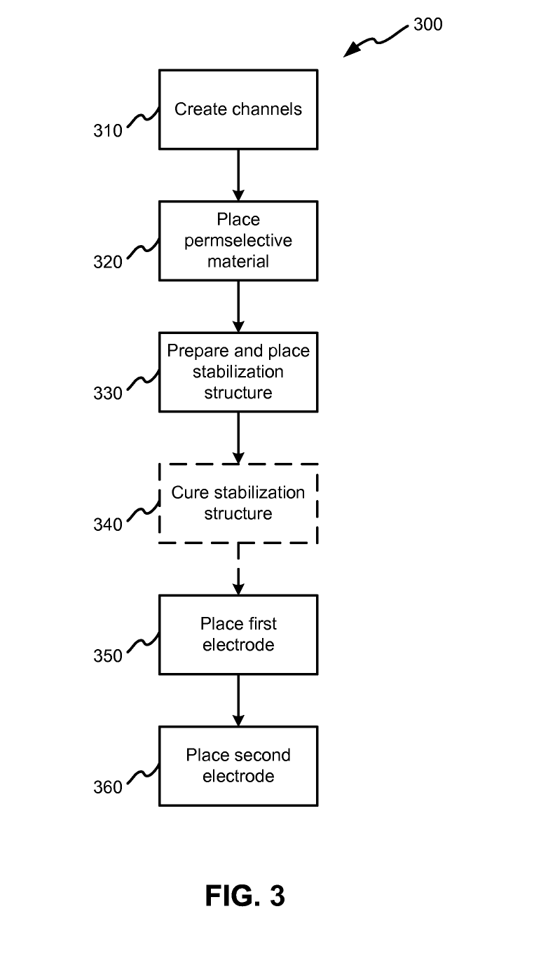

FIG. 3 illustrates a flowchart of an exemplary method 300 for making electrokinetic purification device 100 with turbulence-reduction component 30.

In step 310, method 300 creates main channel 10, at least one waste diversion channel 20 branching from main channel 10 and at least one clean solvent discharge channel 40 branching from main channel 10.

In step 320, method 300 places permselective material 50 across substantially the entire interior cross section of main channel 10, downstream of at least one clean solvent discharge channel 40.

In step 330, method 300 prepares and places a neutrally charged porous material forming turbulence-reduction component 30. This step varies by the porous material used. For example, preparing a porous gel turbulence-reduction component 30 requires combination of the components forming the porous gel. Preparing turbulence-reduction component 30 made up of a frit or porous mass of metal requires obtaining the frit or porous metal, or forming the frit or porous mass of metal from stock. Preparing a bead turbulence-reduction component 30 requires obtaining the beads, or forming the beads from stock. Step 330 places turbulence-reduction component 30 across substantially the entire interior cross section of main channel 10, downstream of at least one waste diversion channel 20 and in contact with upstream surface 51 of permselective material 50.

In optional step 340, method 300 cures the turbulence-reduction component 30 in situ, if using a porous material requiring curing, such as gel.

In step 350, method 300 places a first electrode 17a within main channel 10 such that first electrode 17a will contact solvent stream 88 entering a first segment of main channel 10.

In step 360, method 300 places a second electrode 17b within main channel 10 such that second electrode 17a will contact solvent stream 88 before solvent stream 88 exits a second segment of main channel 10 as purified stream 88c.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale. Instead, emphasis has been placed upon illustrating the principles of the invention. Like reference numerals in the various drawings refer to identical or nearly identical structural elements. Moreover, the terms “substantially” or “approximately” as used herein may be applied to modify any quantitative representation that could permissibly vary without resulting in a change in the basic function to which it is related.

What is claimed is:

1. An electrokinetic purification apparatus comprised of:
a main channel having a first electrode in contact with a solvent stream in a first segment of said main channel and a second electrode in contact with said solvent stream in a second segment of said main channel;
at least one waste diversion channel branching from said main channel, wherein a high concentration portion of said solvent stream flows through said waste diversion channel;
at least one porous permselective material having an upstream surface and a downstream surface, placed across substantially the entire interior cross section of said main channel, requiring said solvent stream to pass though said permselective material between said first and said second electrodes;
a concentration polarization (CP) region within said solvent stream;
a turbulence-reduction component, comprised of a porous material having a neutral charge, wherein said turbulence-reduction component is placed across substantially the entire interior cross section of said main channel and in contact with said upstream surface; and
at least one clean solvent discharge channel branching from said main channel, wherein a low concentration portion of said solvent stream flows through said clean solvent discharge channel and is discharged from said main channel at a point before said solvent stream passes through said permselective material.

2. The device of claim 1, wherein said porous material is a polymer membrane having pores of a diameter between approximately 0.1 microns and approximately 10 mm.

3. The device of claim 1, wherein said porous material is a gel having pores of a diameter between approximately 0.1 microns and approximately 10 mm.

4. The device of claim 3, wherein said gel is selected from the group consisting of agarose and polyacrylamide.

5. The device of claim 1, wherein said porous material is a plurality of beads having pores of a diameter between approximately 0.1 microns and approximately 10 mm.

6. The device of claim 5, wherein said plurality of beads are selected from the group consisting of polymer beads and glass beads.

7. The device of claim 1, wherein said porous material is a frit having pores of a diameter between approximately 0.1 microns and approximately 10 mm.

8. The device of claim 7, wherein said frit is selected from the group consisting of polymer frits, glass frits and metal frits.

9. The device of claim 1, wherein said porous material is a fiber material having pores of a diameter between approximately 0.1 microns and approximately 10 mm.

10. The device of claim 1, wherein said porous material is a porous mass of metal having pores of a diameter between approximately 0.1 microns and approximately 10 mm.

11. The device of claim 10, wherein said porous mass of metal is selected from the group consisting of porous aluminum and porous stainless steel.

12. The device of claim 1, wherein said permselective material is a charged material selected from the group consisting of gel, membrane, polymer, alumina, silica, or zeolite.

13. The device of claim 1, wherein said main channel has a diameter between approximately 10 microns and approximately 100 cm.

14. The device of claim 1, wherein said at least one waste diversion channel comprises a plurality of waste diversion channels.

15. The device of claim 1, wherein said at least one waste diversion channel comprises an annular waste diversion channel at least partially surrounding said main channel.

16. The device of claim 1, wherein said at least one clean solvent discharge channel comprises a plurality of clean solvent discharge channels.

17. The device of claim 1, wherein said at least one clean solvent discharge channel comprises an annular solvent discharge side channel at least partially surrounding said main channel.

18. An electrokinetic purification system comprised of:
a plurality of electrokinetic purification devices, wherein each of said electrokinetic purification devices comprises:
a main channel having a first electrode in contact with a solvent stream entering said main channel and a second electrode in contact with said solvent stream exiting said main channel,
at least one waste diversion channel branching from said main channel, wherein a high concentration portion of said solvent stream flows through said waste diversion channel,
at least one porous permselective material having an upstream surface and a downstream surface, placed across substantially the entire interior cross section of said main channel, requiring said solvent stream to pass though said permselective material between said first and said second electrodes,
a concentration polarization (CP) region within said solvent stream formed by contact of a low concentration region of said solvent stream with said upstream surface,
a turbulence-reduction component, comprised of a porous material having a neutral charge, wherein said turbulence-reduction component is placed across substantially the entire interior cross section of said main channel and in contact with said upstream surface, and
at least one clean solvent discharge channel branching from said main channel, wherein a low concentration portion of said solvent stream flows through said clean solvent discharge channel and is discharged from said main channel at a point before said solvent stream passes through said permselective material;
a primary input channel in fluid communication with a first end of each of said main channels;
a primary output channel in fluid communication with a second end of each of said main channels; and
a housing at least partially surrounding said plurality of electrokinetic purification devices, said primary input channel and said primary output channel.

19. The system of claim 18, wherein said plurality of electrokinetic purification devices number between approximately 2 and approximately 10,000.

20. A method for making an electrokinetic purification device, comprising the steps of:
creating a main channel, at least one waste diversion channel branching from said main channel and at least one clean solvent discharge channel branching from said main channel;
placing a permselective material across substantially the entire interior cross section of said main channel and downstream of said at least one clean solvent discharge channel;
preparing a neutrally charged porous material forming a turbulence-reduction component and placing said turbulence-reduction component across substantially the entire interior cross section of said main channel, downstream of said at least one waste diversion channel and in contact with an upstream surface of said permselective material;
placing a first electrode within said main channel such that said first electrode will contact a solvent stream entering a first segment of said main channel; and
placing a second electrode within said main channel such that said second electrode will contact said solvent stream exiting a second segment of said main channel.
